(19) United States
(12) Patent Application Publication
(10) Pub. No.: US 2015/0291373 A1
(43) Pub. Date: Oct. 15, 2015

(54) WORKPIECES STACKING APPARATUS

(71) Applicant: TOA Industries Co., Ltd., Ota-shi (JP)

(72) Inventors: Yuji KANAI, Ashikaga-shi (JP); Katsumi WATANABE, Ashikaga-shi (JP)

(73) Assignee: TOA Industries Co., Ltd., Ota-shi (JP)

(21) Appl. No.: 14/679,617

(22) Filed: Apr. 6, 2015

(30) Foreign Application Priority Data
Apr. 11, 2014 (JP) 2014-081551

(51) Int. Cl. B65G 57/03; B65G 47/04; B66F 9/06; B65G 15/00

(52) U.S. Cl. CPC B65G 57/035; B65G 15/00; B65G 47/04; B66F 9/06

(57) ABSTRACT

The invention provides a compact and easily movable workpiece stacking apparatus which uses only an electric source as a power source. A workpiece stacking apparatus includes lift bars on which workpieces are stackable and a lift bar drive apparatus which drives the lift bars in the upward and downward directions. The lift bar drive apparatus includes a support pillar which guides the lift bars in the upward and downward directions, a first sprocket, a second sprocket disposed below the first sprocket and guided movably in the upward and downward directions, a roller chain of which one end is fixed to the lift bars and extended from the lift bars to be engaged with the teeth of the first and second sprockets and the other end is fixed so as to hang the second sprocket, and an electric motor which drives and rotates the first sprocket.

### CROSS-REFERENCE OF THE INVENTION

This application claims priority from Japanese Patent Application No. 2014-081551, the content of which is incorporated herein by reference in its entirety.

### BACKGROUND OF THE INVENTION

1. Field of the Invention

The invention relates to a workpiece stacking apparatus which stacks workpieces pressed by a press machine sequentially.

2. Description of the Related Art

Conventionally, a workpiece stacking apparatus (also called a piler apparatus) is known, which carries a workpiece of a metal plate pressed into a predetermined planar shape and discharged by a press machine by a conveyor and stacks the multiple workpieces to form a stack of workpieces. Also known is a workpiece stacking apparatus using a hydraulically-driven pantograph type lifter as a mechanism of lifting up and down a stack while supporting it. A relevant technique is disclosed in Japanese Patent Application Publication No. 2012-56748.

However, a workpiece stacking apparatus using a hydraulically-driven pantograph type lifter needs a hydraulic unit as well as an electric source unit as a power source, causing a problem of increasing the apparatus size and cost. Furthermore, since the body of the hydraulically-driven pantograph type lifter is often built in a pit formed by digging the floor in an apparatus setting area, it is difficult to utilize the area for other work styles by moving the apparatus.

Therefore, the invention provides a compact and easily movable workpiece stacking apparatus which uses only an electric source as a power source.

### SUMMARY OF THE INVENTION

For addressing the problem described above, the invention provides a workpiece stacking apparatus which includes a plurality of lift bars on which workpieces are stackable and a lift bar drive apparatus driving the plurality of lift bars in upward and downward directions. The lift bar drive apparatus includes a support pillar guiding the lift bar in the upward and downward directions, a first sprocket, a second sprocket disposed below the first sprocket and guided movably in the upward and downward directions, a roller chain having one end and the other end, the one end of the roller chain being fixed to the lift bar and extended from the lift bar to be engaged with teeth of the first and second sprockets and other end of the roller chain being fixed so as to hang the second sprocket, and an electric motor driving and rotating the first sprocket.

### BRIEF DESCRIPTION OF THE DRAWINGS

FIG. 1 is a front view of a workpiece stacking apparatus of an embodiment of the invention.

FIG. 2 is a plan view of the workpiece stacking apparatus of the embodiment of the invention.

FIG. 3 is a diagram showing a control structure of the embodiment of the invention.

FIG. 4 is a view explaining the mechanism of a lift bar drive apparatus of the embodiment of the invention.

FIGS. 5A, 5B, 5C and D are views explaining the operation of the workpiece stacking apparatus of the embodiment of the invention.

FIGS. 6A, 6B, 6C and 6D are views explaining the operation of the workpiece stacking apparatus of the embodiment of the invention.

### DETAILED DESCRIPTION OF THE INVENTION

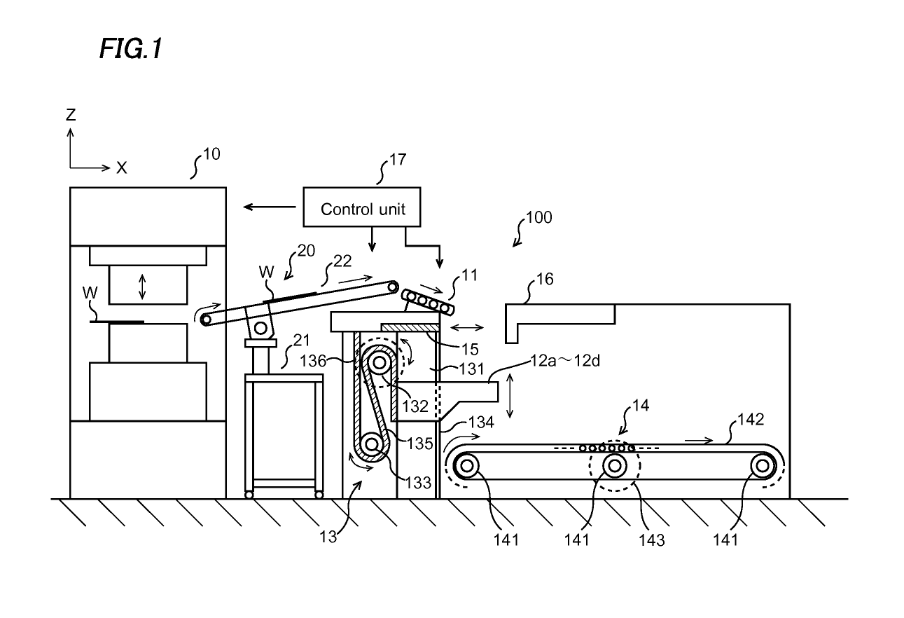

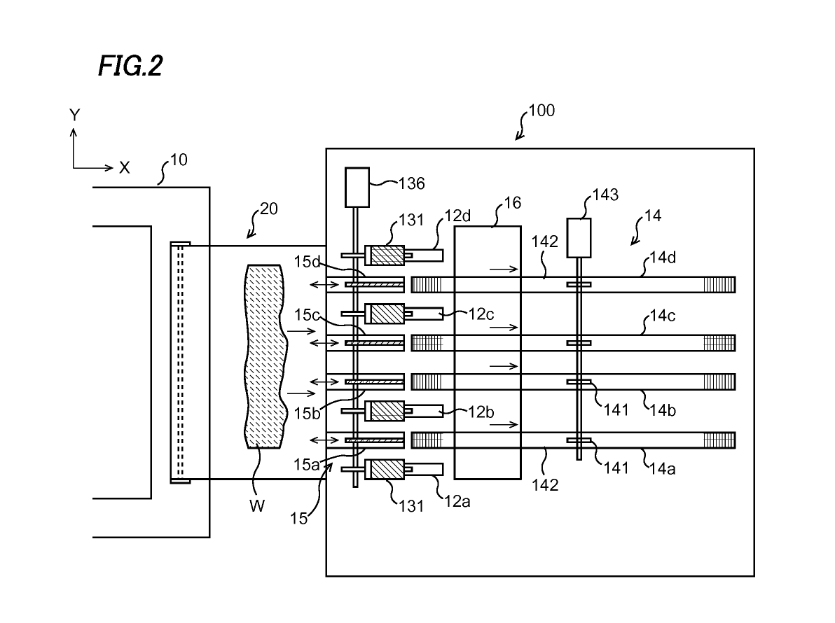

An embodiment of the invention will be described referring to the figures. FIG. 1 is a front view of a workpiece stacking apparatus 100 of the embodiment of the invention. FIG. 2 is a plan view thereof.

A workpiece W of a metal plate which is pressed into a predetermined planar shape by a press machine 10 is carried to the workpiece stacking apparatus 100 by a carry-in conveyor 20 sequentially. The carry-in conveyor 20 is disposed between the press machine 10 and the workpiece stacking apparatus 100, and includes a movable support table 21 and a carry-in conveyor body 22 supported on the support table 21 and adjustable in its inclination.

The workpiece stacking apparatus 100 includes a throw-in conveyor 11 which throws a workpiece W carried from the carry-in conveyor 20 into a workpiece stacking work position above lift bars 12a to 12d (in the Z direction), the four lift bars 12a, 12b, 12c and 12d arrayed at given intervals in the horizontal direction (in the Y direction) on which workpieces W are stackable, and a lift bar drive apparatus 13 driving these lift bars 12a to 12d in the upward and downward directions. The number of the lift bars 12a, 12b, 12c and 12d are not limited to four.

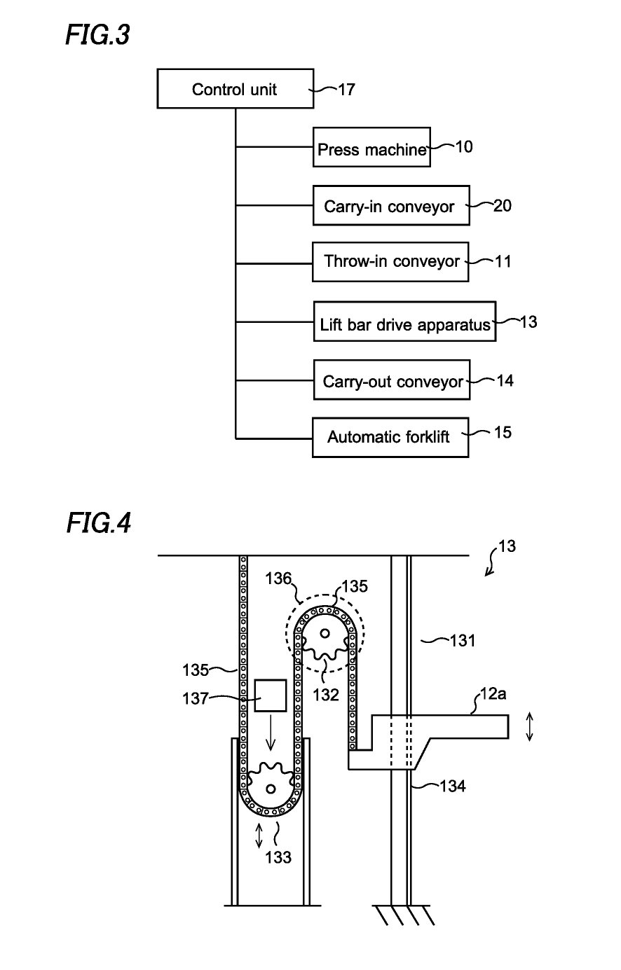

The workpiece stacking apparatus 100 further includes a carry-out conveyor 14 which discharges a stack S of multiple workpieces W stacked on the lift bars 12a to 12d, an automatic forklift 15 which receives a stack S from the lift bars 12a to 12d temporarily, and a workpiece stopper 16 which prevents dropping of workpieces W stacked on the lift bars 12a to 12d and on the automatic forklift 15 in the carrying direction. The operation of the press machine 10, the carry-in conveyor 22, the throw-in conveyor 11, the lift bar drive apparatus 13, the carry-out conveyor 14 and so on is controlled by a control unit 17 formed of, for example, a CPU, as shown in FIG. 3.

The lift bar drive apparatus 13 is provided for each of the four lift bars 12a to 12d so as to drive the lift bars 12a to 12d simultaneously. The structure of the lift bar drive apparatus 13 will be described referring to FIG. 1 and FIG. 4. The lift bar drive apparatus 13 includes a support pillar 131 which guides the lift bar 12a in the upward and downward directions, a first sprocket 132, and a second sprocket 133 disposed below the first sprocket 132 and guided so as to move in the upward and downward directions. A rail 134 is formed in the support pillar 131 in the upward and downward directions, and the lift bar 12a is configured so as to run along this rail 134 in the upward and downward directions.

An end of a roller chain 135 is fixed to an end surface of the lift bar 12a from which the roller chain 135 is extended to be engaged with the teeth of the first and second sprockets 132 and 133 in sequence, and the other end of the roller chain 135 is fixed to the upper frame so as to hang the second sprocket 133. An electric motor 136 is provided so as to simultaneously drive and rotate the first sprockets 132 provided for the four lift bars 12a to 12d respectively. The rotation speed of the electric motor 136 is regulated by a speed reducer.

When the first sprocket 132 rotates counterclockwise, the lift bar 12a moves upward and the second sprocket 133 moves downward. When the first sprocket 132 rotates clockwise, the lift bar 12a moves downward and the second sprocket 133 moves upward.

In this case, a pressing means 137 is provided so as to keep the tension of the roller chain 135 and absorb the slack of the roller chain 135 when the lift bar 12a moves upward and the second sprocket 133 moves downward, the pressing means 137 being engaged with a bearing supporting the rotation shaft of the second sprocket 133 and pressing the second sprocket 133 downward. A cylinder, a spring or the like may be used as the pressing means 137.

The carry-out conveyor 14 is disposed and fixed in a lower portion of the workpiece stacking apparatus 100, and includes four carry-out conveyor units 14a to 14d arrayed in the Y direction which carry a stack S in the X direction as shown in FIG. 2. Each of the carry-out conveyor units 14a to 14d includes a roller chain 142 stretched on a plurality of sprockets 141 arrayed in the X direction, and an electric motor 143 is provided so as to drive and rotate the center sprockets 141 in common.

In this case, in order to prevent the contact of the carry-out conveyor 14 and the lift bars 12a to 12d, as shown in the plan view of FIG. 2, the carry-out conveyor unit 14a is disposed between the lift bars 12a and 12b, the carry-out conveyor units 14b and 14c are disposed between the lift bars 12b and 12c, and the carry-out conveyor unit 14d is disposed between the lift bars 12c and 12d.

The operation of the workpiece stacking apparatus 100 will be described. First, the lift bars 12a to 12d lie in the upper limit position, and workpieces W thrown in by the throw-in conveyor 11, sent from the press machine 10 through the carry-in conveyor 20, are sequentially stacked on the lift bars 12a to 12d. When the height of the stack S on the lift bars 12a to 12d increases to reach a predetermined height, the lift bars 12a to 12d move downward by a predetermined distance. In this manner, as the height of the stack S increases, the lift bars 12a to 12d move downward. The height of the stack S is detected by a light beam sensor.

When the height of the stack S thus reaches the upper limit, the press machine 10 stops and the lift bars 12a to 12d on which the stack S is mounted move downward to the lower limit position. The carry-out conveyor 14 receives the stack S. In this lower limit position, the upper surfaces (the stacking surfaces) of the lift bars 12a to 12d are lower than the carrying surfaces of the carry-out conveyor units 14a to 14d, and thus the stack S is automatically transferred to the carry-out conveyor units 14a to 14d.

The carry-out conveyor 14 is then started and carries the stack S in the X direction to a predetermined position. The empty lift bars 12a to 12d then move from the lower limit position to the upper limit position, and the press machine 10 is restarted. Then, workpieces W thrown in by the throw-in conveyor 11, sent from the press machine 10 through the carry-in conveyor 20, are sequentially stacked on the lift bars 12a to 12d. Thereafter, the same operation is repeated.

In this manner, since the lift bar drive apparatus 13 is formed of the electric motor 136, the first and second sprockets 132 and 133, and the roller chain 135 in the workpiece stacking apparatus 100, the power source is only an electric source supplied to the electric motor 136 and so on, thereby providing a compact and easily movable workpiece stacking apparatus.

In this case, during the time period from when the height of a stack S reaches the upper limit to when the lift bars 12a to 12d transfer the stack S to the carry-out conveyor 14 in the lower limit position and return to the upper limit position, the lift bars 12a to 12d cannot receive a workpiece W. Therefore, it is necessary to stop the press machine 10 during this time period, causing a problem of decreasing the operating ratio of the press machine 10.

For addressing this problem, an automatic forklift 15 is provided which receives workpieces W temporarily during this time period. In detail, after the lift bars 12a to 12d start moving downward toward the lower limit position, this automatic forklift 15 comes out from the waiting position horizontally to the workpiece stacking work position, and stacks workpieces W sent from the press machine 10 thereon to form the next stack S temporarily. The height of this stack S is lower than the upper limit height. When the lift bars 12a to 12d which become empty by transferring the preceding stack S move upward from the lower limit position to the upper limit position again, the automatic forklift 15 transfers the next stack S to the lift bars 12a to 12d and retracts from the workpiece stacking work position to the waiting position.

As shown in FIG. 2, the automatic forklift 15 includes four workpiece support bars 15a to 15b and cylinders which drive these between the waiting position and the workpiece stacking work position. The number of the workpiece support bars is not limited to four. The workpiece support bar 15a is disposed between the lift bar 12a and the lift bar 12b, the workpiece support bars 15b and 15c are disposed between the lift bar 12b and the lift bar 12c, and the workpiece support bar 15d is disposed between the lift bar 12c and the lift bar 12d. Since the height of a stack S stacked on the automatic forklift 15 is lower than the upper limit height, the workpiece support bars 15a to 15b may be formed of thinner and lighter bars than the lift bars 12a to 12d.

The automatic forklift 15 transfers workpieces W to the lift bars 12a to 12d by the lift bars 12a to 12d lifting up the workpieces W since the upper surfaces (the stacking surfaces) of the lift bars 12a to 12d become a little higher than the upper surface (the stacking surface) of the automatic forklift 15. By this, the stopping time period of the press machine 10 is reduced to enhance the operating ratio of the press machine 10. The operation of the automatic forklift 15 is also controlled by the control unit 17.

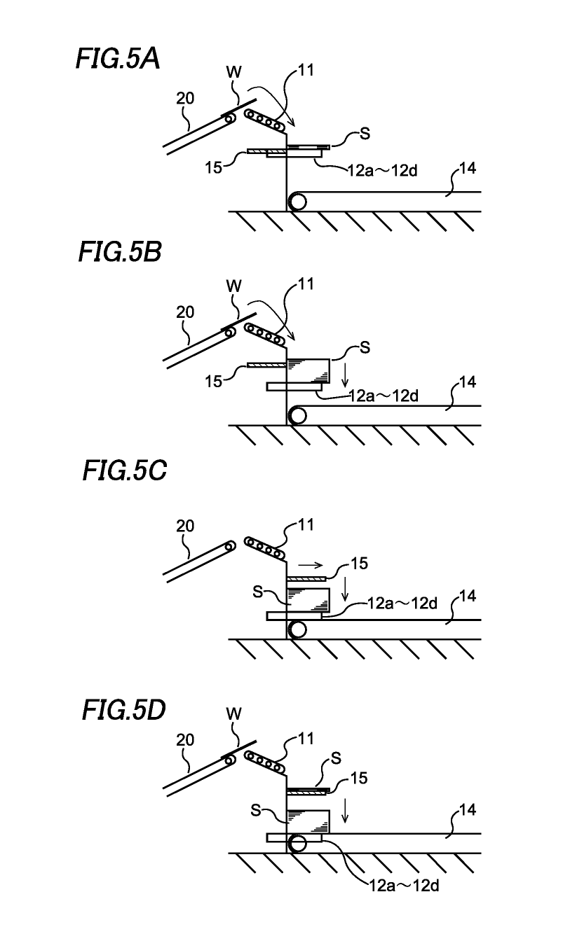

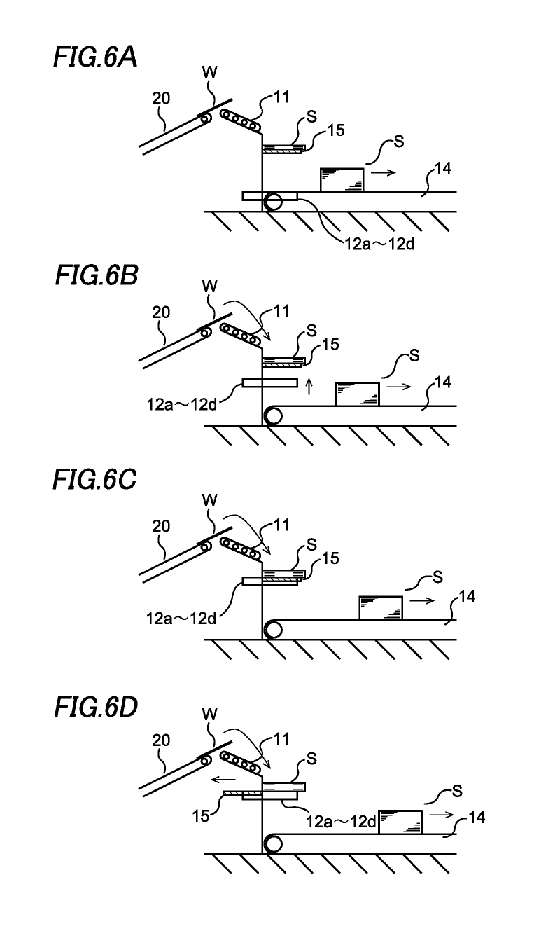

Hereafter, an example of the operation of the workpiece stacking apparatus 100 with the automatic forklift 15 will be described in detail referring to FIGS. 5A to 5D and FIGS. 6A to 6D.

First, as shown in FIG. 5A, the lift bars 12a to 12d are disposed in the upper limit position. Workpieces W carried by the carry-in conveyor 20 and the throw-in conveyor 11 are sequentially stacked on the lift bars 12a to 12d to form a stack S.

Then, as shown in FIG. 5B, when the height of the stack S increases to reach a predetermined height, the lift bars 12a to 12d move downward by a predetermined distance. Then, as shown in FIG. 5C, when the height of the stack S reaches the upper limit, the press machine 10 stops and the lift bars 12a to 12d on which the stack S is mounted move downward toward the lower limit position. Then, when the lift bars 12a to 12d reach the position where these does not contact the automatic forklift 15, the automatic forklift 15 comes out from the waiting position horizontally to the workpiece stacking work position. At this time, the lower surface of the automatic forklift 15 is higher than the height of the upper surface of the stack S.

Then, as shown in FIG. 5D, after the automatic forklift 15 comes out, the press machine 10 is restarted and workpieces W are sequentially stacked on the automatic forklift 15 to form the next stack S. The lift bars 12a to 12d continue moving downward. When the lift bars 12a to 12d reach the lower limit position, the carry-out conveyor 14 receives the stack S from the lift bars 12a to 12d.

Then, as shown in FIG. 6A, the carry-out conveyor 14 is started and the stack S is carried. Then, as shown in FIG. 6B, when the stack S is carried away to the position where it does not contact the lift bars 12a to 12d, the lift bars 12a to 12d start moving upward from the lower limit position toward the upper limit position rapidly. Until the lift bars 12a to 12d reach the upper limit position, workpieces W carried in by the carry-in conveyor 20 and the throw-in conveyor 11 are sequentially stacked on the automatic forklift 15. By this, the stopping time period of the press machine 10 is reduced to enhance the operating ratio thereof.

As shown in FIG. 6C, when the lift bars 12a to 12d move upward to reach the upper limit position, the automatic forklift 15 transfers the workpieces W to the lift bars 12a to 12d. Then, as shown in FIG. 6D , the automatic forklift 15 which transfers the workpieces W to the lift bars 12a to 12d completes its role and retracts from the workpiece stacking work position to the waiting position. Then, workpieces W are sequentially stacked on the lift bars 12a to 12d.

Thereafter, the workpiece stacking apparatus 100 continues carrying stacks S by the carry-out conveyor 14 sequentially by repeating the operation of the FIGS. 5A to 6D.

The press machine 10 stops when the height of a stack S on the lift bars 12a to 12d reaches the upper limit, waits until the automatic forklift 15 comes out to the workpiece stacking work position, and is then restarted. Although the timing of the automatic forklift 15 coming out is prior to the start of the lift bars 12a to 12d moving upward from the lower limit position toward the upper limit position in the operation example described above, it may be during the time period of the lift bars 12a to 12d moving upward toward the upper limit position.

1. A workpiece stacking apparatus comprising:
a plurality of lift bars on which workpieces are stackable; and
a lift bar drive apparatus driving the plurality of lift bars in upward and downward directions,
wherein the lift bar drive apparatus comprises a support pillar guiding the lift bar in the upward and downward directions,
a first sprocket,
a second sprocket disposed below the first sprocket and guided movably in the upward and downward directions,
a roller chain having a first end and a second end, the first end of the roller chain being fixed to the lift bar and extended from the lift bar to be engaged with teeth of the first and second sprockets, and the second end of the roller chain being fixed so as to hang the second sprocket,
and an electric motor driving and rotating the first sprocket.

2. The workpiece stacking apparatus of claim 1, wherein the lift bar drive apparatus is configured to move the plurality of lift bars downward to a lower limit position when a stack of the plurality of workpieces stacked on the plurality of lift bars reaches an upper limit height.

3. The workpiece stacking apparatus of claim 2, wherein the lift bar drive apparatus further comprises a carry-out conveyor which receives the stack from the plurality of lift bars which move downward to the lower limit position and carries the stack in a horizontal direction.

4. The workpiece stacking apparatus of claim 2, further comprising an automatic forklift which comes out from a waiting position to a workpiece stacking work position after the plurality of lift bars start moving downward toward the lower limit position, stacks workpieces thereon temporarily, transfers the workpieces to the plurality of lift bars when the plurality of lift bars move upward from the lower limit position to the upper limit position, and retracts from the workpiece stacking work position to the waiting position.

5. The workpiece stacking apparatus of claim 4, wherein the automatic forklift is configured to come out from the waiting position to the workpiece stacking work position prior to the start of the plurality of lift bars moving upward from the lower limit position toward the upper limit position.

6. The workpiece stacking apparatus of claim 4, wherein the automatic forklift is disposed between the plurality of lift bars in plan view of the workpiece stacking apparatus.

7. The workpiece stacking apparatus of claim 1, wherein the workpiece comprises a pressed metal plate.

8. A workpiece stacking apparatus comprising:
a plurality of lift bars on which workpieces are stackable;
a lift bar drive apparatus driving the lift bars in upward and downward directions;
automatic forklift comprising a plurality of workpiece support bars movable in the upward and downward directions, and
a carry-out conveyor comprising a plurality of carry-out conveyor units,
wherein the lift bars are horizontally shifted from the support bars so as not to overlap in plan view of the workpiece stacking apparatus.

9. The workpiece stacking apparatus of claim 8, wherein the lift bars are horizontally shifted from the carry-out conveyor units so as not to overlap in plan view of the workpiece stacking apparatus.
